(19) United States
(12) Patent Application Publication
(10) Pub. No.: US 2014/0339035 A1
(43) Pub. Date: Nov. 20, 2014

(54) FLOW MODIFICATION FOR A HYDROMOUNT

(71) Applicant: Ford Global Technologies, LLC, Dearborn, MI (US)

(72) Inventors: Mary Theresa Breida, Ann Arbor, MI (US); Thomas Mathai, Farmington, MI (US); Nagari Achar, Troy, MI (US); Hassan Dakhlallah, Dearborn, MI (US); Margaret Brouwer, Dexter, MI (US); Jim Chern, Troy, MI (US)

(73) Assignee: Ford Global Technologies, LLC, Dearborn, MI (US)

(21) Appl. No.: 14/146,633

(22) Filed: Jan. 2, 2014

Related U.S. Application Data
(60) Provisional application No. 61/824,923, filed on May 17, 2013.

(51) Int. Cl. F16F 9/10

(52) U.S. Cl. CPC F16F 9/10
USPC 188/322.13

(57) ABSTRACT

Embodiments may provide a hydromount, an inertial track and a method. The hydromount may a curvilinear inertial track fluidically coupled at a first end to a first fluid chamber, and fluidically coupled at a second end to a second fluid chamber. The hydromount may also include a choke disposed within the inertial track at a predetermined location to reduce a width of a flow path within the inertial track at the predetermined location.

### CROSS REFERENCE TO RELATED APPLICATION

This application claims priority to U.S. Provisional Patent Application No. 61/824,923, filed May 17, 2013, the entire contents of which are hereby incorporated herein by reference for all purposes.

### Field

The present application relates to a hydromount wherein flow through an inertial track therein is easily and effectively changeable.

### BACKGROUND AND SUMMARY

Efforts to reduce the transmission of unwanted vibration and noise from a vehicle engine to other parts of the vehicle may include coupling the engine to the vehicle frame with resilient mounts, and/or struts. One type of mount may be referred to as a hydromount, which may include two fluid-filled resilient chambers fluidically coupled to each other by an inertial track. The resilient chambers and the movement of the fluid through the inertial track may tend to absorb excess movement, damp vibration and reduce noise transmission from the engine to the frame and to the passenger compartment.

One attempt to reduce the level of noise transmitted from the engine to the rest of the vehicle via the vehicle frame is disclosed in U.S. Pat. No. 5,273,261. The patent discloses a hydraulic torque strut with decoupling and a related mounting system. The torque strut includes a “dog bone” assembly including a solid metal rod connecting a pair of tubular rings. Each ring holds a resilient mount. One mount connects to the engine, the other to the frame. One mount is a hydraulic damping insert containing a fluid. The damping and isolation characteristics of the strut mount are intended to be closely tuned to match the operation of the engine, for motion control and noise suppression of the engine.

The inventors herein have recognized several issues with this approach. For example, the approach only attempts to reduce the noise made by the engine and transmitted to the rest of the vehicle. The inventors herein have recognized that the hydromount itself may be a significant source of noise. During operation of a hydromount, there may be fluid flow between the two chambers which may generate flow induced noise. This noise may become amplified based on the vehicle transfer function. When not properly attenuated, the corresponding noise level at passenger compartment may be objectionable. The ability to predict this noise is limited and hence, and may not be assessed until the vehicle intent is better understood. This is not timely, nor cost efficient. The inventors herein have identified flow-restriction as an effective design control to reduce hydromount noise levels. The inventors have also provided a hydromount, an inertial track, and a method wherein flow characteristics of a hydromount can be changed quickly and easily. In this way, a change can be incorporated quickly even if a noise issue is identified at the late stages of vehicle development. In this way, potential noise issues otherwise present with a hydromount may be avoided.

Embodiments in accordance with the present disclosure may provide a hydromount, an inertial track and a method. The hydromount may include a curvilinear inertial track fluidically coupled at a first end to a first fluid chamber, and fluidically coupled at a second end to a second fluid chamber. The hydromount may also include a choke disposed within the inertial track at a predetermined location to reduce a width of a flow path within the inertial track at the predetermined location.

Embodiments may also provide an inertial track for a hydromount which may include an inlet end for receiving a fluid from a first chamber, and an outlet end for passing the fluid to a second chamber. The inertial track may also include a flow restrictor disposed at a predetermined position within the inertial track between the inlet end and the outlet end. The predetermined position may be determined though iterative positioning of the flow restrictor and/or one or more similarly configured other flow restrictors within the inertial track, and/or using similarly shaped and sized inertial tracks with corresponding differing flow restrictor placement(s) and configuration(s). For each iterative positioning of the one or more flow restrictors the hydromount may be subjected to a range of frequency inputs. The sound emitted from the fluid passing through the inertial track in response to the range of frequency inputs may be measured.

Embodiments may also provide method of adjusting a noise level output of an engine mount to a vibration input. The method may include: subjecting one side of the engine mount to a first vibration input; measuring a first level of sound emitted from the engine mount; iteratively repeating the subjecting and the measuring to establish a first noise level output profile for a given range of vibration inputs; changing a first cross-sectional area at a first location of an inertial track included within the engine mount; repeating the iteratively repeating the subjecting and the measuring to establish a second noise level output profile for the given range of vibration inputs; and comparing the second noise level output profile to the first noise level output profile, and determining if the changing the first cross-sectional area at the first location yields an improved noise level output profile.

In this way, a change can be incorporated easily at various stages of engine, and or vehicle development. Even at later stages when changes may typically be difficult.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 is a partial cross-section and partial schematic diagram of an example engine including vibration isolation elements that may be included with one or more engine mounts in accordance with the present disclosure.

FIG. 2 is a top view of an example inertial track that may be included in one or more of the vibration isolation elements illustrated in FIG. 1.

FIG. 3 is a perspective view of the inertial track illustrated in FIG. 2.

FIG. 4 is a top view of another example inertial track that may be included in one or more of the vibration isolation elements illustrated in FIG. 1.

FIG. 5 is a perspective view of the inertial track illustrated in FIG. 4.

FIG. 6 is a top view of another example inertial track that may be included in one or more of the vibration isolation elements illustrated in FIG. 1.

FIG. 7 is a top view of yet another example inertial track that may be included in one or more of the vibration isolation elements illustrated in FIG. 1.

FIG. 8 is a flow diagram illustrating an example method of adjusting a noise level output of an engine mount in accordance with the present disclosure.

FIG. 9 is a flow diagram illustrating a variation of the method illustrated in FIG. 8. FIGS. 2-7 are drawn to scale, however other relative dimensions may be used if desired.

### DETAILED DESCRIPTION

A hydromount for reducing noise, vibration, and harshness (NVH) in the engine as well as the hydromount is described herein. The hydromount may include a curvilinear inertial track fluidically coupled at a first end to a first fluid chamber, and fluidically coupled at a second end to a second fluid chamber and a choke disposed within the inertial track at a predetermined location to reduce a width of a flow path within the inertial track at the predetermined location. It will be appreciated that the choke enables a desired range of frequencies to be attenuated by the hydromount. In this way, NVH may be reduced via the hydromount, thereby increasing customer satisfaction. The size and geometry of the choke may be altered at a late state in the manufacturing process of the hydromount to attenuate desired frequency ranges, if desired. As a result, the adaptability of the hydromount is increased.

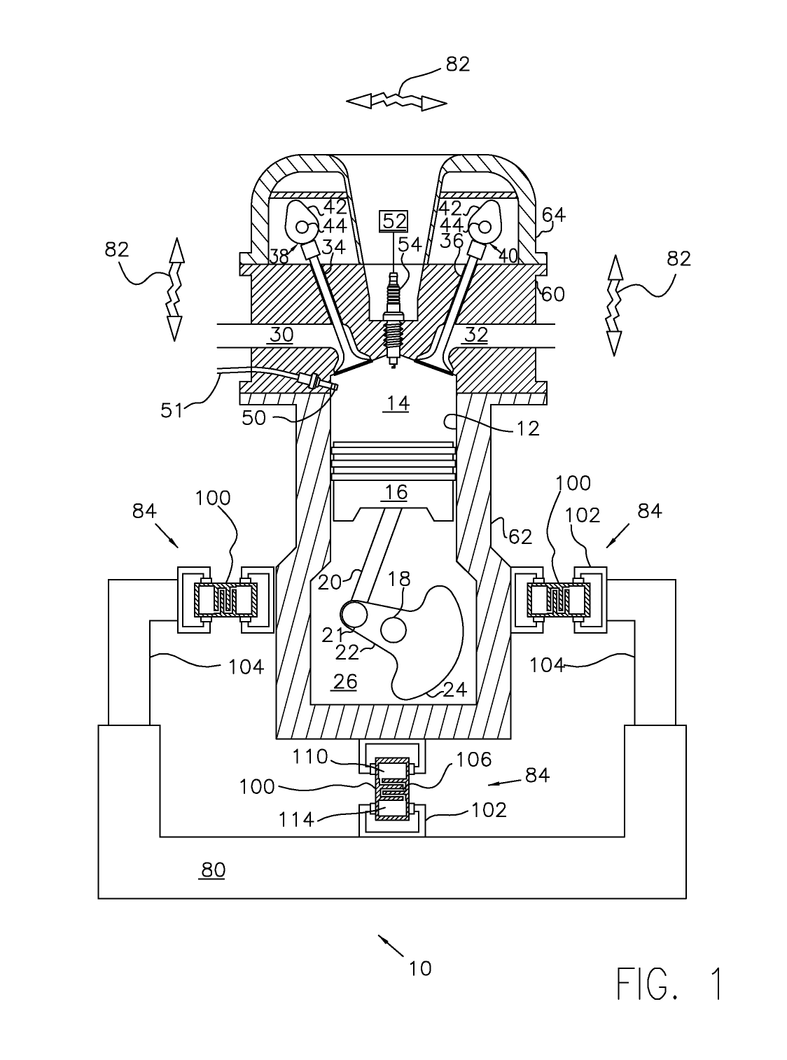

FIG. 1 is a cross-sectional diagram with schematic portions, illustrating a cross-section of an engine 10 in accordance with the present disclosure. Various features of the engine 10 may be omitted, or illustrated in a simplified fashion for ease of understanding of the current description. For example, areas may be illustrated with continuous cross hatching that may otherwise indicate a solid body, however actual embodiments may include various engine components, and/or hollow, or empty, portions of the engine.

The cross-sectional view shown in FIG. 1 may be considered taken through one cylinder 12 of the engine 10. Various components of the engine 10 may be controlled at least partially by a control system that may include a controller (not shown), and/or by input from a vehicle operator via an input device such as an accelerator pedal (not shown). The cylinder 12 may include a combustion chamber 14. A piston 16 may be positioned within the cylinder 12 for reciprocating movement therein. The piston 16 may be coupled to a crankshaft 18 via a connecting rod 20, a crank pin 21, and a crank throw 22 shown here combined with a counterweight 24. Some examples may include a discrete crank throw 22 and counterweight 24. The reciprocating motion of the piston 16 may be translated into rotational motion of the crankshaft 18. The crankshaft 18, connecting rod 20, crank pin 21, crank throw 22, and counterweight 24, and possibly other elements not illustrated may be housed in a crankcase 26. The crankcase 26 may hold oil. Crankshaft 18 may be coupled to at least one drive wheel of a vehicle via an intermediate transmission system. Further, a starter motor may be coupled to crankshaft 18 via a flywheel to enable a starting operation of engine 10.

Combustion chamber 14 may receive intake air from an intake passage 30, and may exhaust combustion gases via exhaust passage 32, which may respectively be referred to as an intake system 11 and an exhaust system 13. Intake passage 30 and exhaust passage 32 may selectively communicate with combustion chamber 14 via respective intake valve 34 and exhaust valve 36. A throttle (not shown) may be included to control an amount of air that may pass through the intake passage 30. In some embodiments, combustion chamber 14 may include two or more intake valves and/or two or more exhaust valves.

In this example, intake valve 34 and exhaust valve 36 may be controlled by cam actuation via respective cam actuation systems 38 and 40. Cam actuation systems 38 and 40 may each include one or more cams 42 and may utilize one or more of cam profile switching (CPS), variable cam timing (VCT), variable valve timing (VVT) and/or variable valve lift (VVL) systems that may be operated by the controller to vary valve operation. The cams 42 may be configured to rotate on respective revolving camshafts 44. As depicted, the camshafts 44 may be in a double overhead camshaft (DOHC) configuration, although alternate configurations may also be possible. The position of intake valve 34 and exhaust valve 36 may be determined by position sensors (not shown). In alternative embodiments, intake valve 34 and/or exhaust valve 36 may be controlled by electric valve actuation. For example, cylinder 12 may include an intake valve controlled via electric valve actuation and an exhaust valve controlled via cam actuation including CPS and/or VCT systems.

In one embodiment, twin independent VCT may be used on each bank of a V-engine. For example, in one bank of the V, the cylinder may have an independently adjustable intake cam and exhaust cam, where the cam timing of each of the intake and exhaust cams may be independently adjusted relative to crankshaft timing.

Fuel injector 50 is shown coupled directly to combustion chamber 14 for injecting fuel directly therein in proportion to a pulse width of a signal that may be received from the controller. In this manner, fuel injector 50 may provide what is known as direct injection of fuel into combustion chamber 14. The fuel injector 50 may be mounted in the side of the combustion chamber 14 or in the top of the combustion chamber 14, for example. Fuel may be delivered via fuel line 51 to fuel injector 50 by a fuel system that may include a fuel tank, a fuel pump, and a fuel rail (not shown). In some embodiments, combustion chamber 14 may alternatively or additionally include a fuel injector arranged in intake passage 30 in a configuration that provides what is known as port injection of fuel into the intake port upstream of combustion chamber 14. The fuel line 51 may be a hose, or passage which may be coupled to a mating engine component, such as cylinder head 60.

Ignition system 52 may provide an ignition spark to combustion chamber 14 via spark plug 54 in response to a spark advance signal from the controller, under select operating modes. Though spark ignition components are shown, in some embodiments the combustion chamber 14 or one or more other combustion chambers of engine 10 may be operated in a compression ignition mode, with or without an ignition spark.

Cylinder head 60 may be coupled to a cylinder block 62. The cylinder head 60 may be configured to operatively house, and/or support, the intake valve(s) 34, the exhaust valve(s) 36, the associated valve actuation systems 38 and 40, and the like. Cylinder head 60 may also support the camshafts 44. A cam cover 64 may be coupled with and/or mounted on the cylinder head 60 and may house the associated valve actuation systems 38 and 40, and the like. Other components, such as spark plug 54 may also be housed and/or supported by the cylinder head 60. A cylinder block 62, or engine block, may be configured to house the piston 16. In one example, cylinder head 60 may correspond to a cylinder 12 located at a first end of the engine. While FIG. 1 shows only one cylinder 12 of a multi-cylinder engine 10, each cylinder 12 may similarly include its own set of intake/exhaust valves, fuel injector, spark plug, etc.

As these and/or other parts may move and/or interact they may cause the engine 10 to move and vibrate relative to a vehicle frame 80 as schematically illustrated with wavy arrows 82. The engine 10 may be coupled to the vehicle frame 80 via coupling configurations 84. The coupling configurations 84, or vibration isolation elements, may, or may not resemble actual coupling configuration, but are meant as schematic representations, and may not be used in actual applications in the combination, and/or numbers, and/or with the attachments points illustrated. The coupling configurations 84 may each include a hydromount 100. One hydromount 100 is shown coupled to the frame 80, and the engine 10 via a bracketing element 102. Two hydromounts 100 are shown coupled to the frame 80, and the engine 10 via a bracketing element 102 and via struts 104. Each hydromount 100 may include an inertial track 106, which may be fluidically coupled at a first end to a first fluid chamber 110 and fluidically coupled at a second end to a second fluid chamber 114.

There are three coupling configurations 84 in the depicted example. Two of the coupling configurations 84 are positioned on opposing sides of the engine and a third coupling configuration is positioned below the other coupling configurations. However, alternate numbers of coupling configurations and/or coupling configuration positions may be utilized in other examples.

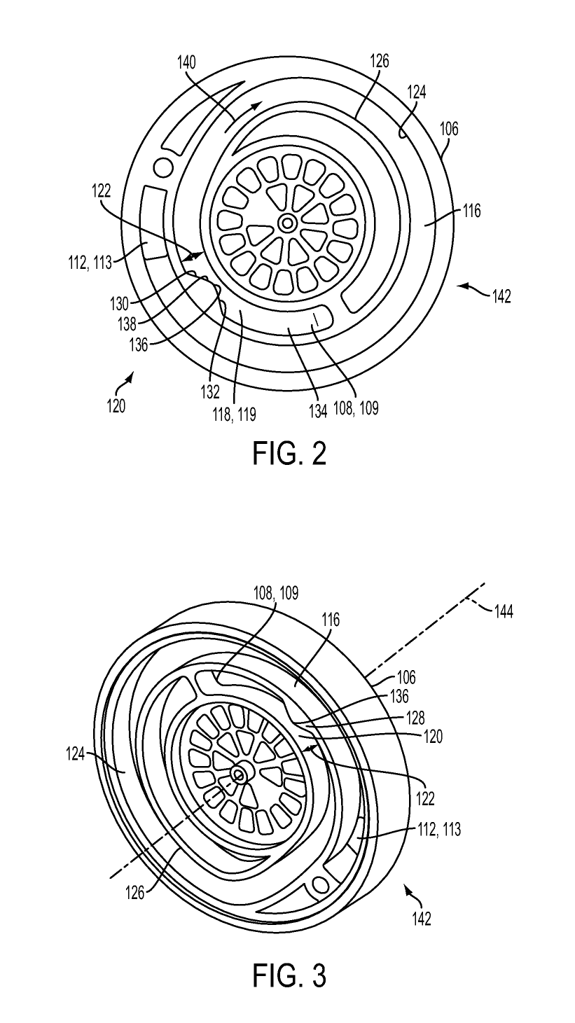

FIG. 2 is a top view of an example inertial track 106 that may be included in one or more of the vibration isolation elements, or hydromounts 105 that may be included with the engine 10 illustrated in FIG. 1. FIG. 3 is a perspective view of the inertial track 106 illustrated in FIG. 2. The inertial track 106 may be sized and shaped to be disposed within the hydromount 100. The hydromount 100 may be configured to allow the inertial track 106 to be replaced with a similarly sized and shaped hydromount 100 with one or more differing features that may enable different behavior of the fluid as it passed through a flow path 116 of the inertial track 106.

The hydromount 106 may include a curvilinear inertial track 106 fluidically coupled at a first end 108 to the first fluid chamber 110 (FIG. 1), and fluidically coupled at a second end 112 to the second fluid chamber 114 (FIG. 1). There may be a choke 118 disposed within the inertial track 106 at a predetermined location 120 to reduce a width 122 of the flow path 116 within the inertial track 106 at the predetermined location 120. The choke 118 may reduce width 122 of the flow path 116 of the inertial track 106 by a preset amount. For example the choke 118 may reduce width 122 of the flow path 116 of the inertial track by approximately 50%. The flow path 116 may be in the shape of a spiral. Thus, at least a portion of the flow path in the inertial track forms a spiral shape. In one example, the cross-sectional area perpendicular to the general flow direction through the inertial track 106 may be substantially constant along the length of the track in portions of the track upstream and downstream of the bumps 128. Additionally, the cross-sectional shape of the inertial track may be oval in one example. However, other internal track geometries have been contemplated.

The inertial track may include an outer curvilinear wall 124 and an inner curvilinear wall 126 spaced from the outer curvilinear wall 124. The choke 118 may be, or may be implemented as, one or more bumps 128 extending into the flow path 116 from one or both of the outer curvilinear wall 124 and the inner curvilinear wall 126.

The one or more bumps 128 may each include a curvilinear profile 130. Other profiles may be used. For example, all or portion(s) of the bumps 128 may have ramping portions. In some cases the one or more bumps 128 may each include a profile 130 shape which approximates a bell curve. The one or more bumps 128 may each include a leading edge face 132 angled to an incoming flow 134 and ramping upward from a surface of one of the outer curvilinear wall 124 and the inner curvilinear wall to a top 136 of each of the one or more bumps, and a trailing edge face 138 angled to an outgoing flow 140 and ramping downward from the top 136 of each of the one or more bumps 128 to the respective surface of one of the outer curvilinear wall 124 and the inner curvilinear wall 126.

It will be appreciated that one or more bumps 128 may extend across the inertial track perpendicular to fluid flow through the inertial track. However, the bumps are curved to reduce the amount of turbulence generated in the inertial track 106. The bumps are configured to restrict flow to reduce vibration via external element as well as in the hydromount. Specifically, the cross-sectional area of the bumps inertial track may be altered at a late stage in the manufacturing process to attenuate a selected range of frequencies, thereby reducing NVH. In this way, the adaptability of the hydromount may be increased, enabling the hydromount to be used in a wide variety of engine and vehicles.

Embodiments may provide a hydromount 100 wherein the inertial track 106 may be formed on disk shaped element 142 having a central axis 144. The first end 108 may be an inlet end 109. The second end 112 may be an outlet end 113, wherein the inlet end 109 may be closer to the central axis 144 than the outlet end 113. Other locations and configurations may be used.

Additionally, the outlet end 113 may be positioned at various angular separations from the inlet end 109. For instance, angles between 30-60 degrees have been contemplated. In other examples, angles between 90-180 degrees have been contemplated. Additionally, the inlet and outlet ends may be in fluidic communication with fluid sources.

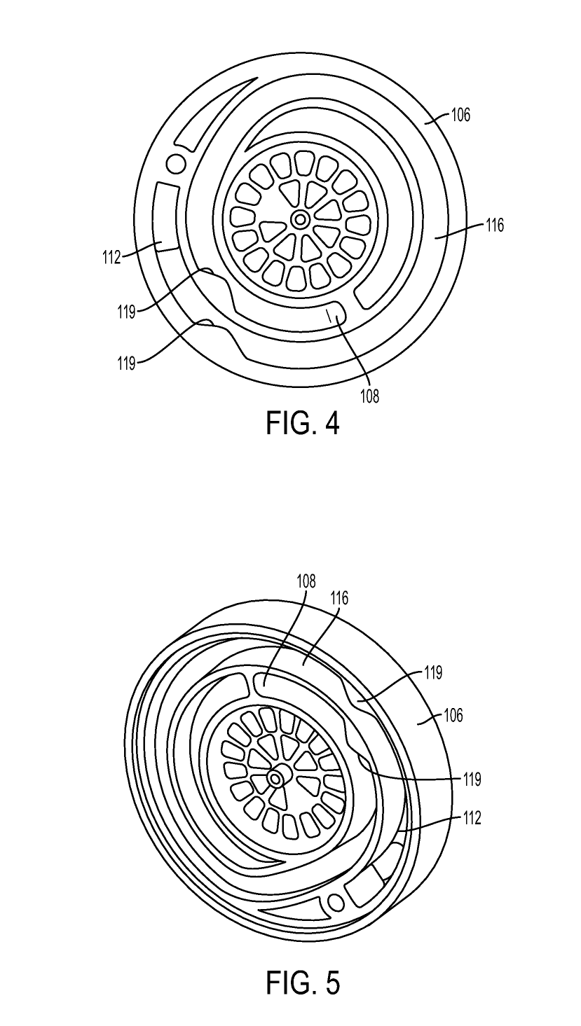

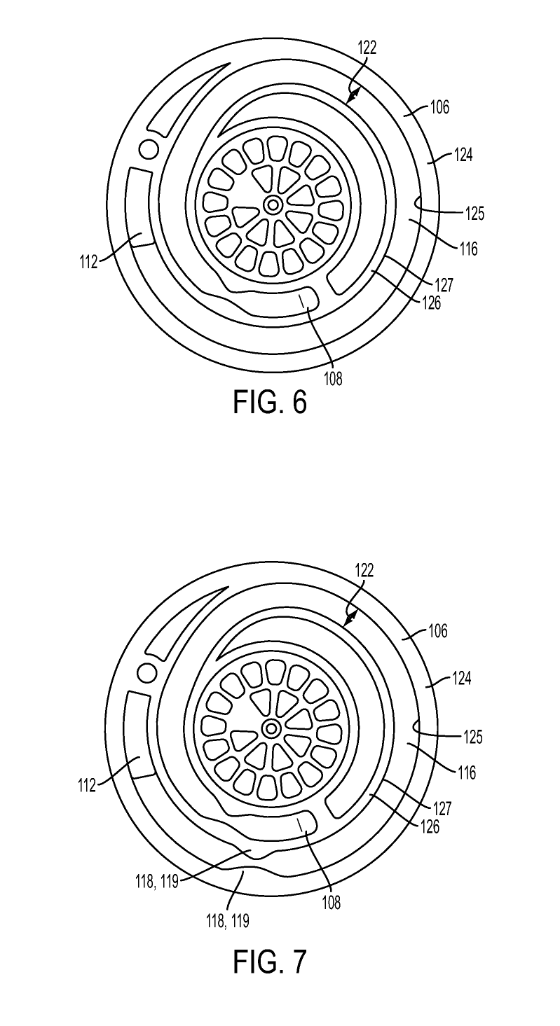

FIGS. 4-7 illustrate some example locations of and configurations of example chokes 188 and bumps 128 in accordance with the present disclosure. FIG. 4 is a top view and FIG. 5 is a perspective view thereof of another example inertial track 106. FIG. 6 is a top view of yet another example inertial track 106; and FIG. 7 is a top view of yet still another example inertial track 106.

Embodiments may provide a hydromount 100 with a choke 118 that may reduce a width 122 of the flow path of the inertial track by approximately 50% at the inlet end 109. In some cases the choke 118 may includes two or more bumps 128 wherein may each restrict the flow path by differing amounts. In some cases the two or more bumps 128 may each restrict the flow path by the same, or similar, amounts. However, in other examples the bumps 128 may each restrict the flow path by varying amounts and therefore have different sizes and/or geometries. For instance, a first bump may restrict the flow path by 30% and a second bump may restrict the flow path by 40%. It will be appreciated that bumps having a variety of flow path restriction percentages have been contemplated. Still further in other examples, the bumps may restrict the flow by similar amounts but have varying geometries.

The choke 118 may be is a first and a second choke 118 wherein the first choke 118 may reduce the width 122 of the flow path 116 at the inlet end 109, and the second choke 118 may reduce the width 122 of the flow path 116 at the outlet end 113. In some example cases the first choke 118 may reduce a width 122 of the flow path 116 by approximately 30% from an inside surface 127 at the inlet end 109, and the second choke 118 may reduce the width 122 of the flow path 116 by approximately 20% from an outside surface 125 at the inlet end 109.

With some examples, such as illustrated in FIG. 7 the choke 118 may be a first, second, third and fourth choke 118. The first choke 118 may reduce a width of the flow path 116 by approximately 30% from an inside surface 127 at the inlet end 109, and the second choke 118 may reduce the width 122 of the flow path 116 by approximately 20% from an outside surface 125 at the inlet end 109. The third choke 118 may reduce a width of the flow path 116 by approximately 30% from an inside surface 127 at the outlet end 113. The fourth choke 118 may reduces the width of the flow path by approximately 20% from an outside surface 125 at the outlet end 113.

Each of FIGS. 2-7 illustrates examples wherein at least a portion of the inertial track 106 may form a spiral path. In some cases, the inertial track 106 may form a different shape. For instance, the inertial track may form a helical shape.

Various example embodiments may provide an inertial track 106 for a hydromount 100. The inertial track 106 may include an inlet end 109 for receiving a fluid from a first chamber 110, and an outlet end 113 for passing the fluid to a second chamber 114. A flow restrictor 119 may be disposed at a predetermined position 120 within the inertial track 106 between the inlet end 109 and the outlet end 113. The predetermined position 120 may be determined though iterative positioning of the flow restrictor and/or one or more similarly configured other flow restrictors 119 within the inertial track 106. Thus, the position of the flow restrictor may be sequentially moved around the inertial track and subjected to vibrations. For each iterative positioning of the one or more flow restrictors 119 the hydromount 100 may be subjected to a range of frequency inputs, and sound emitted from the fluid passing through the inertial track 106 in response to the range of frequency inputs may be measured. It will be appreciated that the frequency inputs may be generated via an external component. In this way, a noise level output profile may be established for a given range of frequency inputs and decisions may be easily made in accordance with the expected use, and/or design of a vehicle, and/or engine. Also in this way, various inertial tracks may be used and/or swapped out in a simple fashion to match desired hydromount behavior in accordance with the expected use, and/or design of a vehicle, and/or engine. In this way, the hydromount may be tuned for a specific end-use designs at a late stage in a manufacturing process. As a result, the adaptability of the hydromount may be increased.

The inertial track 106 may be configured between curvilinear walls 124, 126 included in a disk shaped element 142. The predetermined position 120 may be at or near the outlet end 113. In some cases, the predetermined position 120 may instead, or in addition, be at or near the inlet end 109. The inertial track 106 may include two or more flow restrictors 119 at respective two or more predetermined positions 120 within the inertial track 106. The inertial track 106 may include a second flow restrictor 120 wherein the flow restrictor 119 may be at or near the inlet end 109 and the second flow restrictor is at or near the outlet end 113. In some cases the flow restrictors 119 may include a choke 118 on either an outer surface 125 of the inertial track 106 or an inner surface 127 on the inertial track 106.

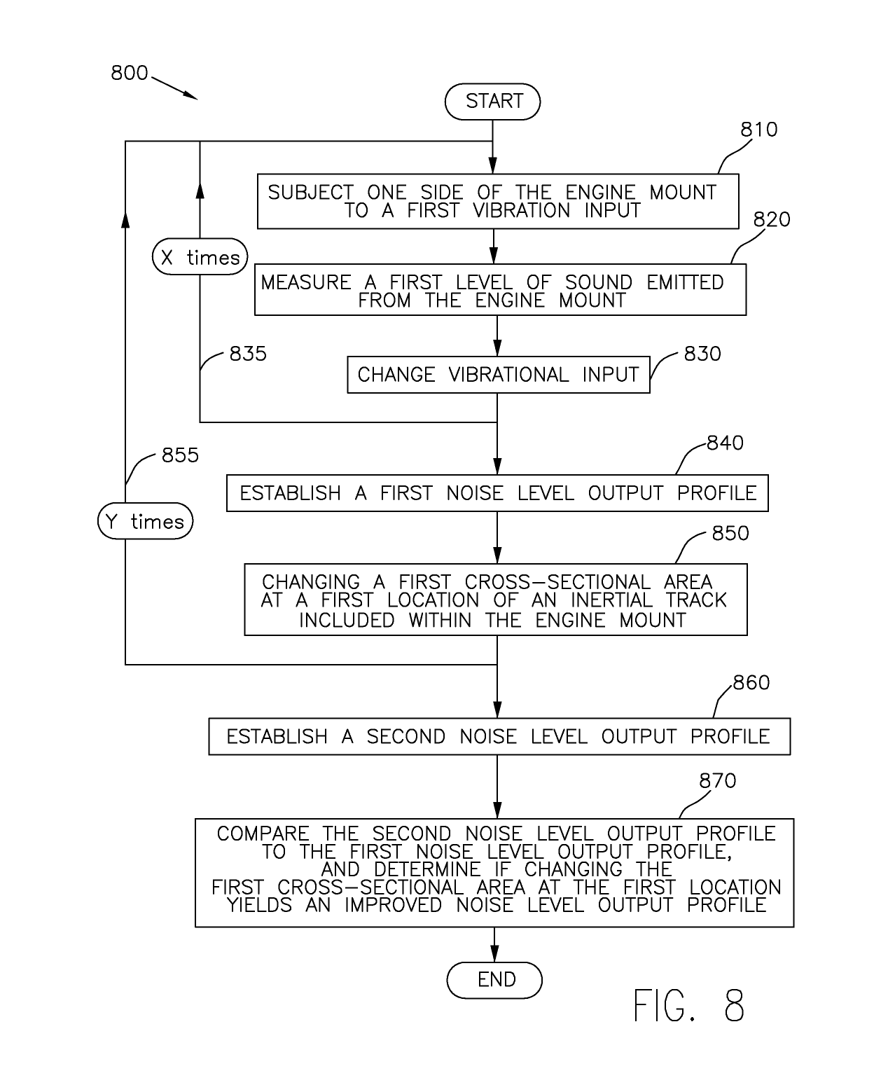

FIG. 8 is a flow diagram illustrating an example method 800 of adjusting a noise level output of an engine mount in accordance with the present disclosure. The method 800 may include, at 810 subjecting one side of the engine mount to a first vibration input. It will be appreciated that the vibration input may be input via an external component. The method 800 may also include, at 820 measuring a first level of sound emitted from the engine mount. Then as illustrated at 830 and with the logic flow path line 835 the method 800 may continue by iteratively repeating, the subjecting 810 and the measuring 820 to, at 840, establish a first noise level output profile for a given range of vibration inputs. The number of iteration may be determined by the number of different frequencies that may be under test.

Then the method 800 may include, at 850, changing a first cross-sectional area at a first location of an inertial track included within the engine mount. The method 800 may then loop back up, as shown with branch 855 and continue the repeating the iteratively repeating, as shown with the nested looping branch 835, the subjecting 810 and the measuring 820 to, at 860, establish a second noise level output profile for the given range of vibration inputs. The method 800 may continue at 870 by comparing the second noise level output profile to the first noise level output profile, and determining if the changing the first cross-sectional area at the first location yields an improved noise level output profile. In this way, the area of the inertial track may be iteratively changed to reduce NVH, thereby improving customer satisfaction.

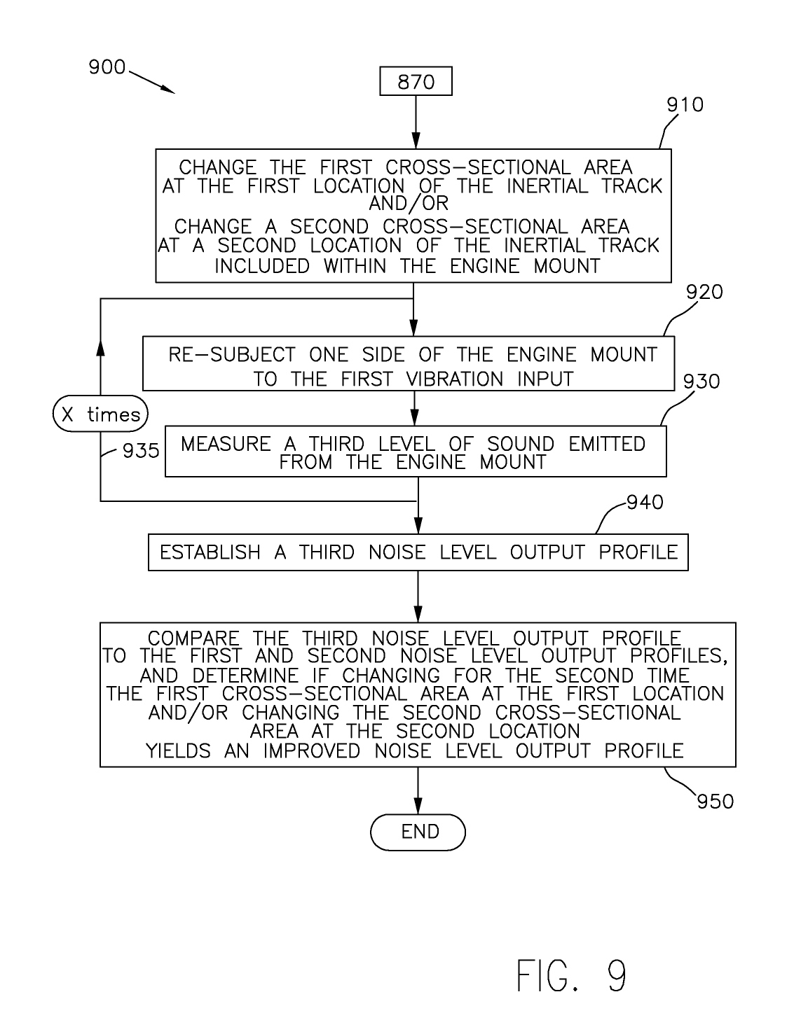

FIG. 9 is a flow diagram illustrating another example method 900 that may be a variation of the method 800 illustrated in FIG. 8. The method 900 may include, at 910, changing for a second time the first cross-sectional area at the first location and/or changing a second cross-sectional area at a second location of the inertial track. The method 900 may also include, at 920, re-subjecting the one side of the engine mount to the first vibration input; and then, at 930, measuring a third level of sound emitted from the engine mount. Then as illustrated at 940 and with the logic flow path line 945 the method 900 may continue by iteratively repeating, the re-subjecting 920 and the measuring 830 to, at 940, establish a third noise level output profile for the given range of vibration inputs. The method 900 may include, at 950, comparing the third noise level output profile to the first and the second noise level output profiles, and determining if the changing for the second time the first cross-sectional area at the first location and/or the changing the second cross-sectional area at the second location yields an improved noise level output profile. In this way, the geometry of the inertial track may be further altered at a late stage in the manufacturing process to decrease NVH, further improving hydromount operation. Moreover, iterative vibration dampening may provide a reliable NVH reduction technique which may be used to reduce NVH in a wide variety of engines, vehicles, etc., thereby increasing the adaptability of the hydromount.

It should be understood that the systems and methods described herein are exemplary in nature, and that these specific embodiments or examples are not to be considered in a limiting sense, because numerous variations are contemplated. Accordingly, the present disclosure includes all novel and non-obvious combinations of the various systems and methods disclosed herein, as well as any and all equivalents thereof.

1. A hydromount comprising:
a curvilinear inertial track fluidically coupled at a first end to a first fluid chamber, and fluidically coupled at a second end to a second fluid chamber; and
a choke disposed within the inertial track at a predetermined location to reduce a width of a flow path within the inertial track at the predetermined location.

2. The hydromount of claim 1, wherein the choke reduces a width of the flow path of the inertial track by approximately 50%.

3. The hydromount of claim 1, wherein the inertial track includes an outer curvilinear wall and an inner curvilinear wall spaced from the outer curvilinear wall, and wherein the choke is one or more bumps extending into the flow path from one or both of the outer curvilinear wall and the inner curvilinear wall.

4. The hydromount of claim 3, wherein the one or more bumps each include a curvilinear profile.

5. The hydromount of claim 3, wherein the one or more bumps each include a profile shape which approximates a bell curve.

6. The hydromount of claim 3, wherein the one or more bumps each include a leading edge face angled to an incoming flow and ramping upward from a surface of one of the outer curvilinear wall and the inner curvilinear wall to a top of each of the one or more bumps, and a trailing edge face angled to an outgoing flow and ramping downward from the top of each of the one or more bumps to the respective surface of one of the outer curvilinear wall and the inner curvilinear wall.

7. The hydromount of claim 1, wherein the inertial track is formed on disk shaped element having a central axis, and wherein the first end is an inlet end and the second end is an outlet end, and wherein the inlet end is closer to the central axis than the outlet end.

8. The hydromount of claim 7, wherein the choke reduces a width of the flow path of the inertial track by approximately 50% at the inlet end.

9. The hydromount of claim 7, wherein the choke is a first and a second choke wherein the first choke reduces a width of the flow path at the inlet end, and the second choke reduces the width of the flow path at the outlet end.

10. The hydromount of claim 7, wherein the choke is a first and a second choke wherein the first choke reduces a width of the flow path by approximately 30% from an inside surface at the inlet end, and the second choke reduces the width of the flow path by approximately 20% from an outside surface at the inlet end.

11. The hydromount of claim 7, wherein the choke is a first, second, third and fourth choke, and wherein the first choke reduces a width of the flow path by approximately 30% from an inside surface at the inlet end, and the second choke reduces the width of the flow path by approximately 20% from an outside surface at the inlet end; and
wherein the third choke reduces a width of the flow path by approximately 30% from an inside surface at the outlet end, and the fourth choke reduces the width of the flow path by approximately 20% from an outside surface at the outlet end.

12. The hydromount of claim 7, wherein at least a portion of the inertial track forms a spiral path and wherein the choke includes two or more bumps each restricting the flow path by differing amounts.

13. An inertial track for a hydromount comprising:
an inlet end for receiving a fluid from a first chamber;
an outlet end for passing the fluid to a second chamber; and
a flow restrictor disposed at a predetermined position within the inertial track between the inlet end and the outlet end, the predetermined position determined though iterative positioning of the flow restrictor and/or one or more similarly configured other flow restrictors within the inertial track, and wherein for each iterative positioning of the one or more flow restrictors the hydromount is subjected to a range of frequency inputs, and sound emitted from the fluid passing through the inertial track in response to the range of frequency inputs is measured.

14. The inertial track of claim 13, wherein the inertial track is configured between curvilinear walls included in a disk shaped element.

15. The inertial track of claim 13, wherein the predetermined position is one or more of at or near the outlet end, and at or near the inlet end.

16. The inertial track of claim 13, further comprising a second flow restrictor and wherein the flow restrictor is at or near the inlet end and the second flow restrictor is at or near the outlet end.

17. The inertial track of claim 13, further comprising two or more flow restrictors at respective two or more predetermined positions within the inertial track.

18. The inertial track of claim 13, wherein the flow restrictors includes a choke on either an outer surface of the inertial track, or an inner surface on the inertial track.

19. A method of adjusting a noise level output of an engine mount to a vibration input comprising:
subjecting one side of the engine mount to a first vibration input;
measuring a first level of sound emitted from the engine mount;
iteratively repeating the subjecting and the measuring to establish a first noise level output profile for a given range of vibration inputs;
changing a first cross-sectional area at a first location of an inertial track included within the engine mount;
repeating the iteratively repeating the subjecting and the measuring to establish a second noise level output profile for the given range of vibration inputs; and
comparing the second noise level output profile to the first noise level output profile, and determining if the changing the first cross-sectional area at the first location yields an improved noise level output profile.

20. The method of claim 19, further comprising:
changing for a second time the first cross-sectional area at the first location and/or changing a second cross-sectional area at a second location of the inertial track;
re-subjecting the one side of the engine mount to the first vibration input;
measuring a third level of sound emitted from the engine mount; and
repeating the iteratively repeating the re-subjecting and the measuring the a third level of sound to establish a third noise level output profile for a the given range of vibration inputs; and
comparing the third noise level output profile to the first and the second noise level output profiles, and determining if the changing for the second time the first cross-sectional area at the first location and/or the changing the second cross-sectional area at the second location yields an improved noise level output profile.
